(19) United States
(12) Patent Application Publication
(10) Pub. No.: US 2005/0019452 A1
(43) Pub. Date: Jan. 27, 2005

(54) Packaging with venting holes for containing a particulate product

(76) Inventors: Patrick J. Sumpmann, Maple Grove, MN (US); Curtis J. Deering, Edina, MN (US); Sarah J. Moberg, Edina, MN (US); William E. Archibald, Atascadero, CA (US); Stuart N. Bernard, Cedar, MN (US)

Correspondence Address: GENERAL MILLS, INC., P.O. BOX 1113, MINNEAPOLIS, MN, 55440, US

(21) Appl. No.: 10/484,181

(22) PCT Filed: Jul. 16, 2001
(86) PCT No.: PCT/US01/22451

Related U.S. Application Data
(63) Continuation-in-part of application No. 09/346,440, filed on Jul. 1, 1999, now Pat. No. 6,261,615.

(51) Int. Cl. C12C 1/027

(52) U.S. Cl. 426/106

(57) ABSTRACT

A packaging for containing a particulate product is disclose in preferred forms of a canister (10) and a bag (100). The packaging includes a body (11, 110) and at least one microhole (40, 400) formed in the body (11, 110). Other than the microhole(s) (40, 400), the body (11, 110) is hermetically sealed. In this regard, the body (11, 110) defines an internal storage region (20, 200) configured to contain a particulate product (22). The microhole(s) (40, 400) are sized to allow passage of air from the internal storage region (20, 200), as well as to limit passage of the particulate product (22). During use, a decrease in atmospheric pressure applied to the packaging, such as during shipping, results in air being vented from the internal storage region (20, 200) via the microhole(s) (40, 400). Due to this air flow, an internal pressure of the body (11, 110) maintains substantial equilibrium with atmospheric pressure such that the body (11, 110) will not unexpectedly expand or in the case of bag (100) burst.

### BACKGROUND OF THE INVENTION

The present invention relates to packaging for containing a particulate product. More particularly, it relates to packaging having venting holes for containing a particulate product, the venting holes facilitating pressure equilibrium at high altitudes.

Extremely popular forms of packaging for dry, particulate products sold to consumers are a paper carton or a printed plastic bag. The paper carton normally is rectangular in shape, constructed of one or more layers of paper, and may or may not include an additional plastic liner. A wide variety of products are packaged in this form, ranging from consumable items such as cereals and baking goods, to non-consumable items such as laundry detergents and de-icing salt pellets. Paper cartons present a number of advantages for manufacturers, retailers and consumers. For example, paper cartons are relatively inexpensive to manufacture and provide a number of flat surfaces onto which product or promotional information can be displayed. Due to the rectangular shape, cartons are readily stackable. Thus, a retailer can maximize shelf space while fully displaying the product. Consumers likewise find the stackability characteristic desirable for home storage. Finally, paper cartons are typically sized in accordance with consumer preferences such that a desired amount or volume of product is provided with each individual carton.

Certain types of products are amenable to storage within a paper carton alone. Generally speaking, however, a paper carton cannot, in and of itself, adequately maintain product integrity. For example, a paper carton likely will not prevent aroma, moisture, contaminants, small insects, etc. from passing through to the contained product. Thus, paper cartons for virtually all particulate-type products require an additional container or liner disposed within the paper carton. This is especially true for consumable/food products. A widely accepted technique for maintaining product integrity is to place the product into an inner container or bag, that in turn is stored in the carton (commonly referred to as a “bag in a box”). The bag is typically made of a plastic or glassine material and is, in theory, sealed about the product. In this sealed form, the bag maintains product freshness and provides protection against insect infestation, whereas the outer paper carton provides packaging strength and display. Alternatively, a double packaging machine (DPM) technique may be employed to form a plastic or glassine liner within a paper carton. Regardless of the exact manufacturing process, the resulting packaging configuration includes a box with an inner liner that serves as a barrier material. For virtually all applications, a large volume of air will be “contained” within the inner liner in addition to the particulate-type product. That is to say, the particulate-type product will not encompass the entire internal volume of the inner liner, and may include spacing between individual product particles.

As described above, a concerted attempt is made to hermetically seal the inner liner about the particulate-type product. On a mass production basis, however, current packaging technology cannot consistently meet this goal. For example, small openings may remain at an apex of two inner liner film sheets joined to one another. In short, manufacturers accept the fact that some leakage will occur into and out of the inner liner through one or more small openings. Although unexpected, these openings normally are not large enough for passage of contaminants or discharge of product. In fact, the openings may provide a benefit during shipping. Packaged product is typically shipped via truck from the manufacturer to retailers at various locations. The location (e.g., city or town) of a particular retailer often is at a greater altitude than that of the manufacturer, or the route traveled by the truck may include a relatively drastic change in altitude. With increasing altitude, the atmospheric pressure exerted on the carton decreases. Because the carton/inner liner is not hermetically sealed, the pressure differential causes air to vent from the inner liner, thereby bringing an internal pressure of the packaging into equilibrium with the now lower atmospheric pressure. Were the inner liner hermetically sealed, this release of air could not occur, resulting in expansion of the inner liner. This expansion may damage the inner liner/carton. Additionally, where a quantity of cartons are closely packed within a corrugated shipping container, expansion of the inner liners may cause the cartons to tightly lodge against one another, rendering removal of the packages from the shipping container extremely difficult.

From a manufacturer's standpoint, a paper carton with an inner liner packaging satisfies a number of important criteria including low cost, stackability, and large, flat surfaces for displaying product and promotional information. Unfortunately, however, consumers may encounter several potential drawbacks. These possible disadvantages are perhaps best illustrated by reference to a ready-to-eat cereal product, although it should be understood that a wide variety of other products are similarly packaged.

Most ready-to-eat cereal products are sold to consumers in a paper carton with an inner liner packaging format. To consume the cereal, the user must first open the paper carton. In this regard, a top portion of the carton typically forms at least two flaps folded on top of one another. The flaps are initially at least partially adhered to one another with an adhesive. By pulling or otherwise tearing one flap away from the other, a consumer can then access the inner bag. An all too common problem is that the selected adhesive creates too strong of a bond between the flaps, making flap separation exceedingly difficult.

Once the carton has been opened, the consumer must then open the inner bag. Once again, this may be a cumbersome procedure. More particularly, an elongated seal is typically formed and extends along a top portion of the bag. This seal is broken (or “opened”) by pulling apart opposite sides of the bag. In some instances, the so-formed seal is too rigid for simple opening. Even further, a person with reduced dexterity and strength, such as a child or elderly individual, may have difficulty in breaking an even relatively light seal. As a result, attempts at opening the inner bag or liner often result in an undesirable tear along a side of the bag, causing unacceptable product displacement from the bag, or an uneven opening. The consumer may resort to using a knife or scissors, possibly resulting in bodily harm.

Once the carton and bag or liner has been opened, the consumer is then ready to pour the contents from the package. Due to the flexible nature of the inner bag, the actual opening through which the product flows is unpredictable. That is to say, the opening formed in the bag is not uniform or fixed. As a result, a larger than expected volume of product may unexpectedly pour from the container. Alternatively, where the inner bag has not been properly opened, product flow may be unacceptably slow. Further, an inherent bias or bend typically causes the flaps to extend upwardly relative to a top of the carton. Thus, the flaps will impede a user from visually confirming acceptable product volume and flow. Additionally, the inner bag typically is not secured to the carton. During a subsequent pouring operation, then, the entire bag may undesirably release from the carton.

A further consumer concern relating to box with an inner liner packaging stems from attempts to reclose the package for subsequent storage of remaining product. Again with reference to widely employed ready-to-eat cereal packaging, following dispensing of a portion of the cereal from the package, the user is then required to roll or fold the top portion of the bag or liner over onto itself so as to “close” the bag. It is not uncommon for a user to simply forget to perform this operation. Alternatively, even where an attempt is made, the bag cannot be resealed and thus remains at least partially open. Similarly, the bag may subsequently unroll. Individual cereal pieces may be undesirably released from the bag and/or contaminants can enter into the bag. Regardless, a reclosure feature normally associated with the carton normally does not provide an effective barrier to unexpected product displacement and/or contamination due to removal, poor design, misuse, lack of use, etc. These concerns are exacerbated when attempting to store a previously-opened package on its side or when the package is accidentally dropped. In either case, because neither the carton nor the bag provides a complete closure, unanticipated release of cereal from the container may occur.

Viewed as a whole, concerns relating to standard box with an inner liner packaging present numerous opportunities for consumer dissatisfaction. Essentially, consumer preferences for improvements to particulate-type product packaging can be separated into four categories. Consumers prefer that the packaging be easy to open, easily and satisfactorily reclosed, facilitate consistent and easy pouring and is acceptable for “clean” use by a child or others with limited dexterity. Obviously, consumers further prefer that product costs be as low as possible, and that certain other beneficial attributes associated with the existing box with inner liner packaging continue to be implemented. These existing properties include package strength, product damage protection, use of high volume commercially available materials, visual display of product and promotional material, recycleability, stackability, and moisture, aroma, contaminant and insect protection.

Certain other packaging schemes are available that address, at least in part, several of the above-listed consumer preferences. Unfortunately, however, these packaging techniques entail other drawbacks, thereby limiting their usefulness. For example, rigid plastic containers having removable, sealable lids are available. The greatly increased costs associated with this packaging configuration prohibit its implementation on a mass production basis. Similarly, it may be possible to provide the inner bag with a “zip-lock” sealing feature. While this technique may alleviate several of the reclosure issues previously described, the zip-lock design is expensive and often times does not provide a complete seal importantly, with these and other envisioned packaging schemes, consistent formation of a hermetic seal will result in the above-described expansion concerns when the package is shipped to a high altitude location. Once again, because the packaging technique does not account for necessary venting, an increase in altitude may cause problematic package expansion.

Consumers continue to express a high demand for particulate-type products sold in a paper cartons. However, various problems associated with use of standard packaging, and in particular box with an inner liner packages, may diminish purchasing enthusiasm. Alternative packaging designs may satisfy some consumer concerns, but in fact create new problems, such as deleterious package expansion during shipment to higher altitude locations.

The printed plastic bag or pouch without the use of a carton or canister is also very popular for a wide variety of products ranging from consumables such as potato chips and candy bars to non-consumables such as fertilizer and water softener salt. The bag or pouch is made up of one or more polymers and is typically made up of multiple layers of one or more polymers. It may also contain aluminum foil, metallized films, or other barrier materials that have been condensed or coated onto one or more layers of the plastic film.

Plastic pouches have several characteristics that make them desirable for manufactures, retailers and consumers. For example, pouches are inexpensive, use fewer unit operations, and have high gloss appearance. Pouches can be displayed on the retail shelf or hung on pegs. Pouches are easily sized to fit consumer purchase desires and create less waste for the consumer to dispose of.

Certain products are pouched and sent through distribution channels without the structural support of a paperboard carton, corrugated container or other materials used to minimize damage to the product. However, for consumable food products that do not use a paperboard carton around the pouch, it is most common to utilize a corrugated container to protect the contents of the pouch from the physical rigors of product distribution.

Typically, the food product is put into a preformed or “form, fill, seal” pouch that has been printed with the necessary graphics prior to being formed into a pouch. The pouch provides barriers to elements that may either egress or ingress the pouch. Examples are moisture, flavors, aromas, oxygen, insects, and dirt. With most consumable food products, the majority of the volume of the pouch is air, including the air that surrounds and is between discrete pieces and the air that is contained within the lattice or cellular structure of the food itself. In some instances, pouches have enough air or other gas to provide a cushion that can prevent breakage of larger particulate materials in handling or distribution. In others, the air is either mechanically or chemically removed from the pouch resulting in a very tight compressed appearing package.

Pouches sold without the added protection of a paperboard carton must be robust. These pouches must withstand the rigors of distribution and give the consumer confidence that the product is high quality and wholesome. Typically, these pouches have very high seal integrity with virtually no air leaks. This is especially true of salty snack packaging. However, the consumer also expects to be able to easily open snack packaging with minimal effort, typically utilizing what is described in the industry as a peelable seal.

Very high seal integrity with a peelable seal creates a special problem for those particulate products that are shipped from a lower elevation to a higher elevation. As the elevation of the pouch increases, the differential pressure between elevations causes the volume of the air in the pouch to increase. The increase in volume of air forces the pouch to expand primarily in the front to back dimension of the pouch. Once the constraints of the corrugated container are met and the pouch continues to increase in elevation, the pouch will develop internal air pressure. If it develops enough pressure, it will burst through the weakest portion of the pouch, typically the seal area and especially the peelable seal.

There are several potential remedies for this situation. Most of which have serious drawbacks ranging from cost to consumer usage. As an example, the seal strength could be increased enough to eliminate bursting, but the package is not convenient for consumers and the material costs would be greater. Vacuum packaging the product would remove the breakage cushion and would result in a less desirable appearance which would adversely affect market appeal as well as increase packaging costs.

Therefore, a need exists for a particulate product packaging configured to address consumer use preferences while providing adequate venting upon shipment over high elevations.

### SUMMARY OF THE INVENTION

One aspect of the present invention provides a packaging for containing a particulate-type product. The packaging includes a body and microholes formed in the body. The body defines an internal storage region. The microholes formed in the body are sized for allowing air flow from the internal storage region, while limiting passage of particulate-type product from the internal storage region. With this configuration, other than the microholes, the body is substantially hermetically sealed. As the packaging is physically moved from a low altitude to a high altitude, atmospheric pressure acting upon the body decreases. The microholes compensate for this decrease in atmospheric pressure by allowing a sufficient volume of air to vent from the internal storage region. Thus, an internal pressure of the body remains in substantial equilibrium with atmospheric pressure such that the body does not overly expand. In one preferred embodiment, the packaging is configured as a canister to maintain a food product such as a ready-to-eat cereal.

Another aspect of the present invention relates to a packaged good article comprising packaging and a particulate-type product. The packaging includes a body and microholes formed in the body. The body defines an internal storage region. The microholes are configured to allow air flow from the internal storage region. Other than the microholes, the body is substantially hermetically sealed. The particulate-type product is disposed within the internal storage region. With this in mind, the microholes are sized to limit, preferably prevent, release of the particulate-type product from the internal storage region. In one preferred embodiment, the particulate-type product is a dry, ready-to-eat cereal.

Yet another aspect of the present invention relates to a method of manufacturing a packaged good article. The method includes forming a hermetically sealable packaging having an internal storage region. Microholes are imparted into the packaging, extending from an exterior of the packaging to the internal storage region. The internal storage region is then partially filled with a particulate-type product. A majority of the remaining volume of the internal storage region not otherwise occupied by the particulate-type product is filled with air. This air within the internal storage region imparts an internal pressure onto the packaging. Upon a decrease in atmospheric pressure acting upon the packaging, the microholes allow venting of a sufficient of air from the internal storage region to equilibrate the internal pressure with atmospheric pressure. In one preferred embodiment, the internal storage region is partially filled with a ready-to-eat cereal.

### BRIEF DESCRIPTION OF THE DRAWINGS

FIG. 1 is a perspective view of packaging in a preferred form of a canister in accordance with the present invention with a portion cut away;

FIG. 2 is an enlarged, cross-sectional view of a portion of the canister of FIG. 1;

FIG. 3 is an exploded, side view of the canister of FIG. 1;

FIG. 4 is a perspective view of the canister of FIG. 1 depicting venting of air;

FIG. 5 is a perspective view of packaging in a preferred form of a bag in accordance with the present invention;

FIG. 6 is an enlarged, cross-sectional view of an encircled portion of the bag of FIG. 5;

FIG. 7 is a perspective view of a truck for shipping a plurality of shippers each containing a plurality of bags of FIG. 5, with portions shown in phantom, broken away, in cross-section, and enlarged; and

FIG. 8 is a diagrammatic view illustrating shipping over a mountain range.

### DETAILED DESCRIPTION OF THE PREFERRED EMBODIMENTS

Packaging for containing particulate products according to the preferred teachings of the present invention are shown in the drawings. Particularly, the sealable nature of the packaging facilitates its use in containing a wide variety of non liquid or particulate products. For example, the particulate product 22 to be packaged can be a food product, and in particular a dry food product. One specific category of available food products included processed grain (e.g., formed from wheat, oats, rice, etc.), processed or dried fruit, or unprocessed small particulate based or any shelf stable food that is ready to eat without further processing. These include ready-to-eat cereals such as puffs, flakes, shreds and combinations thereof. Further, the ready-to-eat cereal product can include other ingredients such as dried fruits, nuts, dried marshmallows, sugar coatings, etc. These also include snacks such as potato or corn chips, pretzels, puffed grain products prepared from cooked cereal doughs and especially fried puffed products, and especially preferred corn (maze) based products such as prepared from cornucopia shaped pellets, or mixtures and combinations thereof. Alternatively, other particulate dry food products can be maintained by the packaging, such as, for example, popcorn (popped or unpopped), dried pasta (e.g., spaghetti noodles), rice, beans, preformed fruit bits, nuts, sugar, flour, dried milk, etc. Even further, other consumable items such as birdseed can be used as the particulate product 22. Yet even further, non-consumable particulate-type products 22 can be contained including fertilizer pellets, dry laundry detergent, dry dishwashing detergent, plant or vegetable seeds, de-icing salt pellets, etc. Regardless of the exact product selected for the particulate product 22, the sealable nature of the packaging maintains integrity of the particulate product 22.

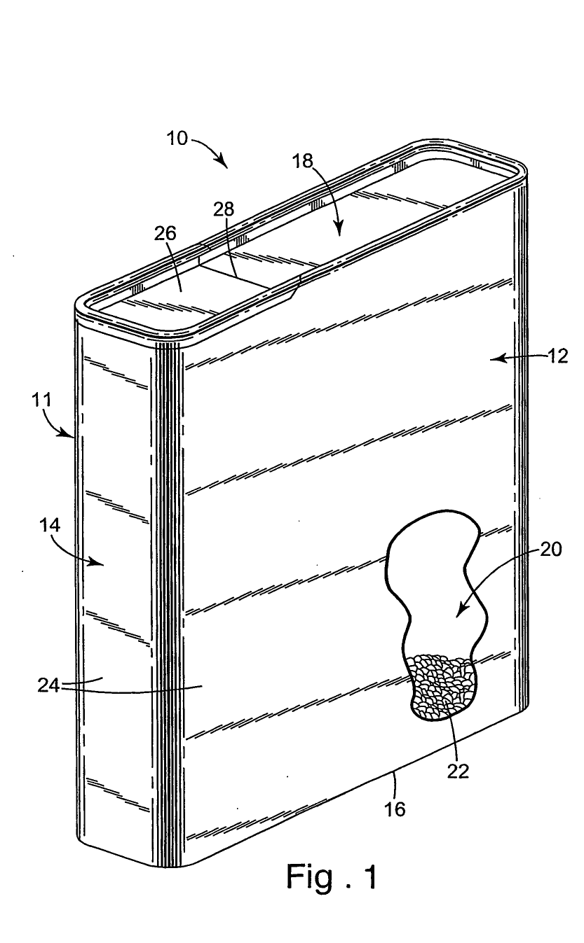

One preferred embodiment of packaging according to the teachings of the present invention is shown in FIG. 1 as a canister 10. The canister 10 is comprised of a canister body 11 that preferably includes opposing face panels 12 (one of which is shown in FIG. 1), opposing side panels 14 (one of which is shown in FIG. 1), a bottom panel or closure 16 (shown partially in FIG. 1) and a top panel or closure 18. As described in greater detail below, the opposing face panels 12 and the opposing side panels 14 are connected to one another. The bottom panel 16 is connected to the opposing face panels 12 and the opposing side panels 14 at a lower portion thereof. Similarly, the top panel 18 is connected to the opposing face panels 12 and the opposing side panels 14 at an upper portion thereof. This configuration provides for an internal storage region 20 (shown partially in FIG. 1), within which a particulate-type product 22 is disposed, and an outer surface 24 onto which product or promotional information can be displayed. Notably, directional terminology such as “bottom,” “top,” “upper” and “lower” is used for purposes of illustration and with reference to a desired upright orientation of the canister 10 as shown in FIG. 1. However, the canister body 11 can be positioned in other orientations such that the directional terminology is in no way limiting.

Each of the panels 12-18 is preferably formed from a paper and plastic material. For example, in one preferred embodiment, a layer of plastic is adhered or laminated to a layer of paper (such as label stock or paperboard) to form each of the panels 12-18. Multiple layers of plastic and/or paper can also be employed. Alternatively, a plastic material or resin can be intertwined with the fibers of a paper material. The combination paper and plastic materials is preferably recyclable and provides a functional barrier to various contaminants, such as flavor, aroma, moisture, oil, grease, other contaminants, insects, etc. Further, the selected plastic must be suitable for contact with the particulate-product 22. For example, where the particulate-type product 22 is a food product, the selected plastic material must be approved for food contact, as is well known in the art. Thus, for example, the plastic material can be polyethylene (low density or high density), chlorinated plastic, ethylene vinyl acetate, polyester, nylon, polypropylene, etc. Even further, the plastic can be various co-polymers, blends or a combination of plastic materials.

By forming the panels 12-18 from a combination of paper and plastic or other sealable materials, the resulting canister 10 is hermetically sealable. In other words, upon final construction, the internal storage region 20 is sealed about the particulate-type product 22. Notably, the same result can be accomplished with other manufacturing techniques, such as by incorporating a separate plastic liner that is hermetically sealed. Additionally, additional materials may be employed to ensure a hermetic seal. For example, in one preferred embodiment, the top panel 18 is configured to form a hinged lid 26 that is pivotable along a score line 28 to provide access to the particulate-type product 22. With this construction, an additional plastic membrane (not shown) is sealed to the canister body 11 below the lid 26 to ensure an air tight seal. Alternatively, a hermetically sealable characteristic can be achieved by shapes other than a rectangular cylinder. Thus, the canister body 11 can assume a wide variety of other configurations including circular, triangular, etc. Further, the bottom panel 16 and the top panel 18 can be eliminated such that the canister body 11 is hermetically sealed by simply sealing closed the opposing face panels 12 and the opposing end panels 14 at upper and lower portions thereof.

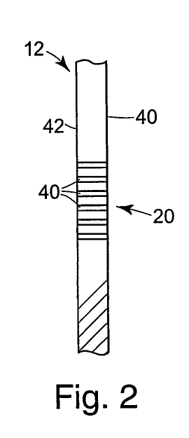

Due to the sealable nature of the canister 10, a plurality of microholes 40 are imparted in a most preferred form into at least one of the panels 12-18 as shown in FIG. 2. As a point of reference, the plurality of microholes 40 is shown in FIG. 2 as extending through one of the opposing face panels 12. It should be understood, however, that the plurality of microholes 40 may be formed in both of the opposing face panels 12, one or more of the opposing side panels 14 (FIG. 1), the bottom panel 16 (FIG. 1) and/or the top panel 18 (FIG. 1). Regardless, the face panel 12 is shown in FIG. 2 as defining an outer surface 42 and an inner surface 44. The outer surface 42 of the face panel 12 corresponds with the outer surface 24 of the canister body 11 shown in FIG. 1. Conversely, the inner surface 44 corresponds with an innermost surface of the canister body 11 (i.e., defining the internal storage region 20 shown generally in FIG. 2). Each of the plurality of microholes 40 extends between the outer surface 42 and the inner surface 44. With this configuration, the plurality of microholes 40 provides for fluid communication between the internal storage region 20 and the atmosphere surrounding the panel 12 (and thus the canister body 11). Thus, the plurality of microholes 40 allows for air flow into and out of the internal storage region 20 that is otherwise hermetically sealed by the canister body 11. Notably, where the canister 10 is constructed to include an additional plastic liner or other structure that hermetically seals the internal storage region 20, the plurality of microholes 40 will extend through that additional structure.

In a preferred embodiment, each of the plurality of microholes 40 are uniformly formed, having a diameter in the range of approximately 10-100 micrometers; more preferably 60-80 micrometers; most preferably 70 micrometers. Experiments have revealed that insects and other potential contaminants, such as moisture, cannot pass through holes with diameters less 100 micrometers. Thus, even with the formation of the plurality of microholes 40, the face panel 12, and any other of the panels 12-18 (FIG. 1) through which microholes are imparted, will continue to serve as a contaminant barrier. Similarly, microhole diameters of less than 100 micrometers are sufficiently small so as to prevent passage of the particulate-type product 22 (FIG. 1) from the internal storage region 20. In this regard, most particulate-type products sold to consumers include individual particles having diameters or widths well in excess of 5 millimeters and therefore will not release from the internal storage region 20 via the plurality of microholes 40. It is recognized that for many products, and in particular food products, individual particles may periodically break or partially disintegrate. For example, a ready-to-eat cereal product may include individual flakes coated with sugar. During handling, portions of the sugar coating may break away from the individual flakes, resulting in an even smaller particle. Experiments have shown that a microhole having a diameter of less than 100 micrometers will not allow passage of these reduced-sized particles. In fact, experiments conducted with canisters containing flour have revealed that individual flour particles will not be released through microholes that are 70 micrometers in diameter.

Conversely, a microhole diameter greater than approximately 10 micrometers is sufficiently large to allow passage of air. Thus, as described in greater detail below, air flow into and out of the internal storage region 20 is facilitated by the plurality of microholes 40 each having a diameter of at least approximately 10 micrometers.

A final concern relating to a preferred diameter of the plurality of microholes 40 relates to consistent, cost effective mass production. As should be apparent from the above, it is preferable to form the plurality of microholes 40 as small as possible so as to limit passage of contaminants and undesired release of product. While a variety of techniques are available for generating microholes, such as with a YAG or carbon dioxide laser, effective large scale production requires relatively rapid formation of a number of microholes. With this in mind, currently available technology can consistently form 70 micrometer microholes 40 on a high-speed packaging line. Thus, in the preferred embodiment, each of the plurality of microholes 40 has a diameter of approximately 70 micrometers.

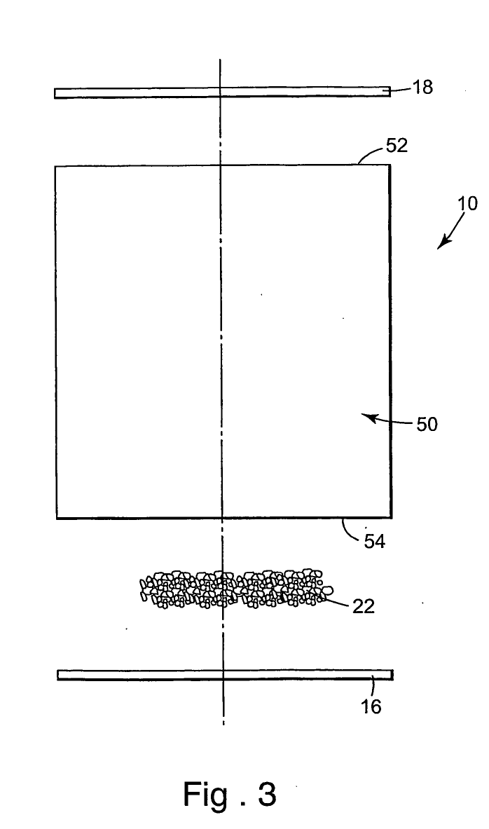

One preferred method of manufacturing the canister 10 is best described with reference to FIG. 3. The opposing face panels 12 and the opposing side panels 14 are connected so as to define a tubular body 50 having an upper opening 52 (shown partially in FIG. 3) and a lower opening 54 (shown partially in FIG. 3). In this regard, the opposing face panels 12 and the opposing side panels 14 are preferably integrally formed, such as by wrapping a sheet of preformed material about an appropriately shaped mandrel (not shown). Opposing edges of the sheet are sealed to form the tubular body 50. Alternatively, the opposing face panels 12 and the opposing side panels 14 can be separately formed, and subsequently connected to one another. The top panel 18 is then connected to the tubular body 50 so as to encompass the upper opening 52. Alternatively, the upper opening 52 can simply be sealed closed. The particulate product 22 is then placed within the internal storage region 20 (FIG. 1) defined by the tubular body 50. Finally, the bottom panel 16 is connected to the tubular body 50 so as to encompass the lower opening 54. Alternatively, the lower opening 54 can simply be sealed closed.

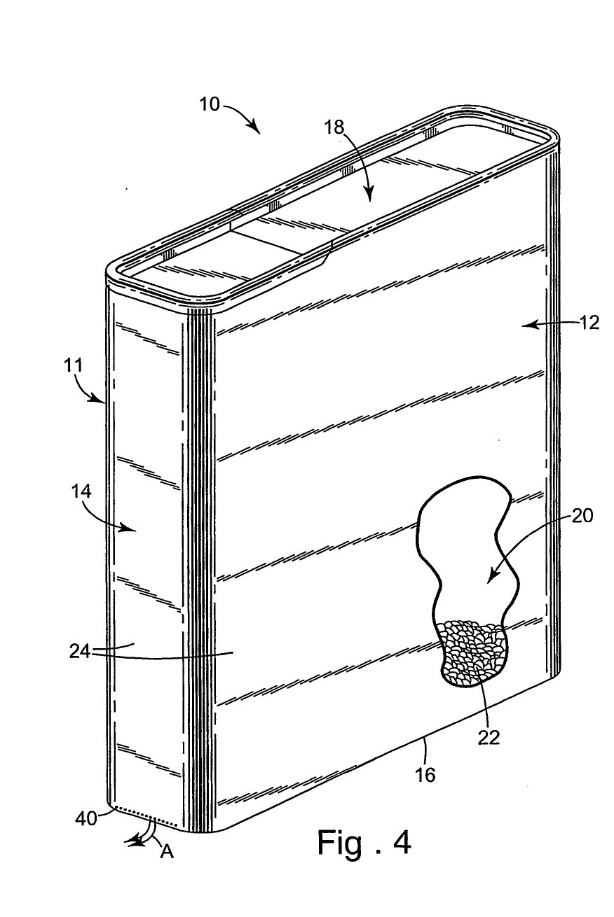

At some point in the manufacturing process, preferably prior to placement of the particulate product 22 within the internal storage region 20 (FIG. 1), the plurality of microholes 40 are formed. For example, in one preferred embodiment, the plurality of microholes 40 are formed in one of the opposing face panels 12 as shown in FIG. 3. Thus, for example, where the tubular body 50, otherwise defined by the opposing face panels 12 and the opposing side panels 14 (FIG. 1), is formed by wrapping a layer of material about a mandrel, the plurality of microholes 40 can be imparted in that layer prior to articulation about the mandrel. Alternatively, or in addition, the plurality of microholes 40 can be formed in one or more of the opposing side panels 14, the bottom panel 16 and/or the top panel 18. As shown in FIG. 4, the plurality of microholes 40 are preferably positioned so as to be at least partially hidden from a consumer, for example near an edge of the canister body 11. Alternatively, the outer surface 24 can include printing that may assist in obscuring the plurality of microholes 40 from view.

An important concern related to the step of creating the plurality of microholes 40 is determining a relatively exact number of microholes required. As described in greater detail below, the plurality of microholes 40 serve to substantially maintain pressure equilibrium of the canister 10. More particularly, the plurality of microholes 40 provide for venting of air from the internal storage region 20 upon a decrease in atmospheric or barometric pressure acting on an exterior of the canister 10. This situation commonly occurs upon shipping of the canister 10 from a low altitude location to a high altitude location. Under these circumstances, the increase in altitude corresponds with a decrease in atmospheric pressure, requiring the venting of air from the internal storage region 20 to maintain integrity of the canister 10. With this in mind, a desired number of the plurality of microholes 40 directly relates to the amount of air within the internal storage region 20, the change in expected altitude and therefore atmospheric pressure, and the rate at which the canister 10 will experience the change in the altitude and therefore atmospheric pressure.

Determining the volume of air maintained within the internal storage region 20 preferably includes estimating a compressed volume of the particulate-type produce 22 in conjunction with an overall volume of the internal storage region 20. In this regard, it is recognized that most products used as the particulate-type product 22 are typically porous and shaped such that spacing between individual particles will occur. For example, where the particulate-type product 22 is a ready-to-eat cereal, the individual cereal particles can be puffed and therefore include air (e.g., puffed rice, wheat, etc.). Additionally, the individual cereal particles typically have non-linear outer surfaces (e.g., flakes, rings, etc.). Thus, while the ready-to-eat cereal may substantially “fill” the inner storage region 20, a large volume of air remains. In one preferred embodiment, to determine the actual volume of air, the canister 10 is first filled to a normal fill level with the particulate-type product 22. The particulate-type product 22 is then removed from the canister 10 and compressed. A volume of the resulting compressed product is then compared with an overall volume of the internal storage region 20. The difference between these values approximates a volume of air within the internal storage region under normal production conditions. For example, it has been found that for most ready-to-eat cereal products, air occupies 80-95 percent of a volume of the internal storage region 20.

The expected, maximum decrease in atmospheric pressure value can be ascertained by comparing normal atmospheric pressure at a very low altitude, such as 100 feet (30 meters) with a relatively high altitude, such as 8,600 feet (2600 meters). For example, in the United States, there are very few cities that are at altitudes of 8,600 feet (2600 meters) or greater. Thus, it can safely be assumed that the canister 10 will be shipped to a location having an altitude of 8,600 feet (2600 meters). It should be noted that given that the canister 10 will likely be shipped via truck 320, the canister 10 may actually experience altitudes higher than the cities of destination as the highway system frequently reaches elevations higher than 8600 feet (2600 meters). Finally, the rate at which the canister 10 will experience this change in altitude must be determined. Once again, with reference to standard delivery practices, the canister 10 will be shipped by truck 320. With this in mind, it is likely that under even the most extreme conditions, it will take at least 60 minutes for the canister 10 will travel from a minimum elevation of 100 feet (30 meters) to an elevation of 8,600 feet (2600 meters).

With values for volume of air, initial altitude, final altitude and time within which the canister 10 will experience the change in altitude, a determination of the number of microholes 40 can be made. For example, the amount of air that must vent from the canister to prevent expansion can be determined by the following equation:
OV=(AV_{I}×APX/APM)−AV_{I}
Where
OV=Overflow Volume air to be released
AV_{I}=Initial Volume of Air
APX=Maximum atmospheric pressure; and
APM=Minimum atmospheric pressure

The rate at which the air must vent from the internal storage region 20 relates to the amount of air that must escape (or overflow volume) and the time period over which the canister 10 is subjected to the change in altitude. For example, flow rate can be determined by the following equation:
FR=OV/T
Where:
FR=flow rate (volume/second)
T=time period for change in altitude
   Notably, where T is expressed in terms of minutes, it will be necessary to convert the time period to seconds to provide a flow rate in terms of volume/second.

The total cross-sectional area of the plurality of holes 40 can then be determined based upon the above values and a determination of an average pressure differential between atmospheric pressure and pressure of the internal storage region 20. For example, where the canister 10 is shipped by truck 320 from a low elevation to a high elevation, it can be assumed that the canister 10 will experience an average pressure differential of 0.1 psi. Alternatively, an estimation can be made as to the flow rate provided by a certain number of microholes 40 formed at a known diameter. For example, experiments have been performed utilizing microholes 40 having diameters of 70 micrometers. These tests have shown that the flow rate of air in cubic centimeters (cm³) per second through a 70 micrometer hole bears a direct relationship to the pressure differential in psi. For example, with a pressure differential of 0.5 psi, a 70 micrometer hole will vent air at 0.025 cm³ per second; and at 0.1 psi, a 70 micrometer hole will vent air at 0.005 cm³ per second. Thus, 200, 70 micrometer microholes 40 will provide a flow rate of 1 cm³ per second at a pressure differential of 0.1 psi. Thus, where the required flow rate is known, multiplying that known value by 200 provides the required number of 70 micrometer holes for adequate venting at a pressure differential of 0.1 psi.

Based upon the above determinations, the following table was generated for various canisters 10 containing 90 percent air traveling from an initial altitude of 100 feet (30 meters) (29.82 inches Hg, 0.7574 meters Hg) to maximum altitude of 8,600 feet (2600 meters) (21.32 inches Hg 9.5415 Hg) over the course of 60 minutes:

| | | | | | | Cross-Section |
|---|---|---|---|---|---|---|
| Canister | Canister | Air Volume | Required | Required | No. of 70 | Total Area of |
| Size | Size | In Canister | Overflow | Flow Rate | Micrometer | Microholes |
| (in³) | (cm³) | (cm³) | (cm³) | (cm³/sec) | Microholes | (cm²) |
| 1306 | 21392 | 19253 | 7676 | 2.13 | 426 | 0.01641 |
| 699 | 11450 | 10305 | 4108 | 1.14 | 228 | 0.00878 |
| 662 | 10844 | 9759 | 3891 | 1.08 | 216 | 0.00832 |
| 611 | 10008 | 9007 | 3591 | 1.00 | 200 | 0.00768 |
| 522 | 8550 | 7695 | 3068 | 0.85 | 170 | 0.00656 |
| 485 | 7944 | 7150 | 2851 | 0.79 | 158 | 0.00610 |
| 444 | 7273 | 6545 | 2610 | 0.72 | 145 | 0.00558 |
| 396 | 6486 | 5838 | 2327 | 0.65 | 129 | 0.00498 |
| 375 | 6143 | 5528 | 2204 | 0.61 | 122 | 0.00471 |
| 374 | 6126 | 5514 | 2198 | 0.61 | 122 | 0.00470 |
| 321 | 5258 | 4732 | 1887 | 0.52 | 105 | 0.00403 |
| 316 | 5176 | 4658 | 1857 | 0.52 | 103 | 0.00397 |
| 272 | 4455 | 4010 | 1599 | 0.44 | 89 | 0.00342 |
| 230 | 3767 | 3391 | 1352 | 0.38 | 75 | 0.00289 |
| 222 | 3636 | 3273 | 1305 | 0.36 | 72 | 0.00279 |
| 209 | 3423 | 3081 | 1228 | 0.34 | 68 | 0.00263 |
| 192 | 3145 | 2830 | 1128 | 0.31 | 63 | 0.00241 |
| 164 | 2686 | 2418 | 964 | 0.27 | 54 | 0.00206 |
| 154 | 2523 | 2270 | 905 | 0.25 | 50 | 0.00194 |
| 150.2 | 2460 | 2214 | 883 | 0.25 | 49 | 0.00189 |
| 143 | 2342 | 2108 | 840 | 0.23 | 47 | 0.00180 |
| 128 | 2097 | 1887 | 752 | 0.21 | 42 | 0.00161 |

The above table sets forth examples of microhole determinations for various canister volumes based upon certain parameters relating to volume of the particulate-type product 22, an initial altitude (and pressure), a final altitude (and pressure) and a time for change in altitude (and pressure). It should be understood, however, that there are many extensions, variations and modifications of the basic themes of the present invention beyond that shown in the table which are within the spirit and scope of the present invention. For example, a diameter other than 70 micrometers can be chosen for the plurality of microholes 40. Further, the selected particulate-type product 22 may have an increased or decreased compressed volume, thereby altering the amount of air maintained within the canister 10. Generally speaking, however, under the most ardent conditions (i.e., a drastic change in altitude), for a canister 10 having an internal storage region volume in the range of approximately 2,000-4,000 cm³ and a particulate-type product having a compressed volume in the range of approximately 200-800 cm³, the plurality of microholes 40 have a total cross-sectional area in the range of approximately 0.001-0.004 cm². Alternatively, for an internal storage region having a volume in the range of approximately 2,000-4,000 cm³ and a particulate-type product having a compressed volume in the range of approximately 200-800 cm³, approximately 40-100 microholes are provided.

A slight deviation in the exact number of microholes 40 actually formed will likely not result in canister failure. In fact, by forming additional microholes, adequate venting can be ensured. Importantly, however, it is desirable that an overall cross-sectional area of the plurality of microholes 40 not exceed ⅛ inch (0.32 cm).

Upon final assembly, the canister 10 can be shipped from a low elevation to a high elevation without experiencing undue expansion due to changes in atmospheric pressure. As shown in FIG. 4, for example, as the canister 10 is raised from a low altitude to a high altitude, atmospheric pressure acting on an exterior (or outer surface 24) of the canister 10 decreases. A pressure differential develops between atmospheric (or external) pressure and an internal pressure of the internal storage region 20, causing air within the internal storage region 20 to vent from the canister 10 via the plurality of microholes 40, as represented by the arrow A in FIG. 4. With proper venting, the external and internal pressures acting upon the canister 10 remain in substantial equilibrium. Therefore, the canister 10 will not unexpectedly expand or otherwise fail. Further, a series of similarly constructed canisters 10 can be shipped in a corrugated shipping container without concern for potential unpacking problems due to canister expansion at increased elevations.

The canister 10 of the present invention provides a marked improvement over previous designs. The canister 10 includes a hermetically sealable canister body 11 able to maintain the integrity of a contained particulate-type product 22. Further, by incorporating a plurality of microholes 40, canister expansion concerns encountered during normal shipping are avoided. In this regard, the requisite number of microholes 40 for adequate venting can accurately be determined for any size canister 10.

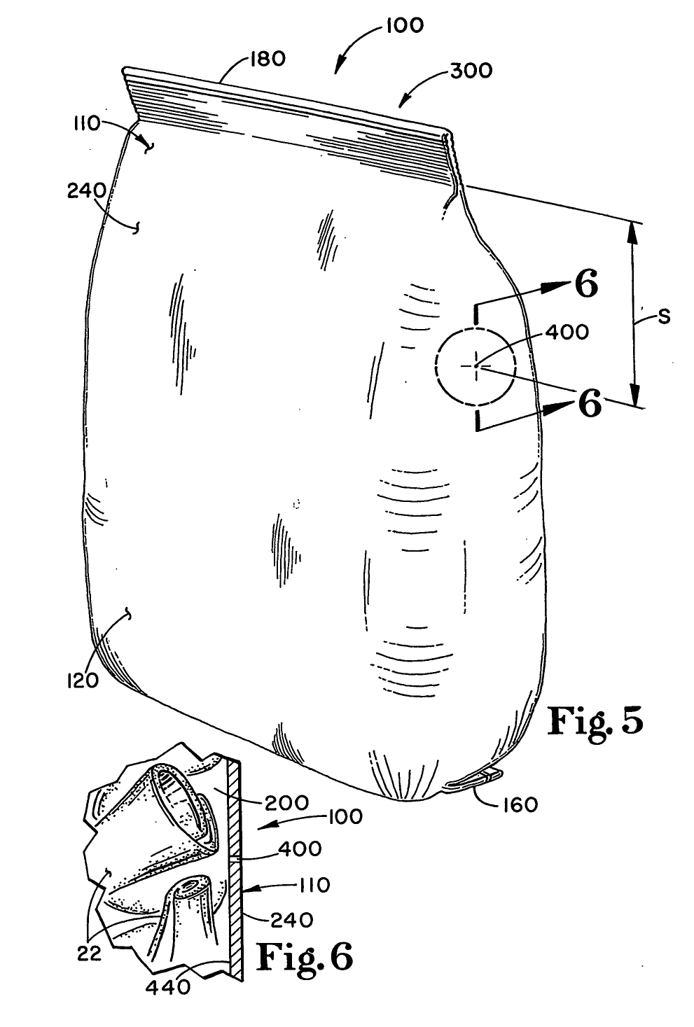

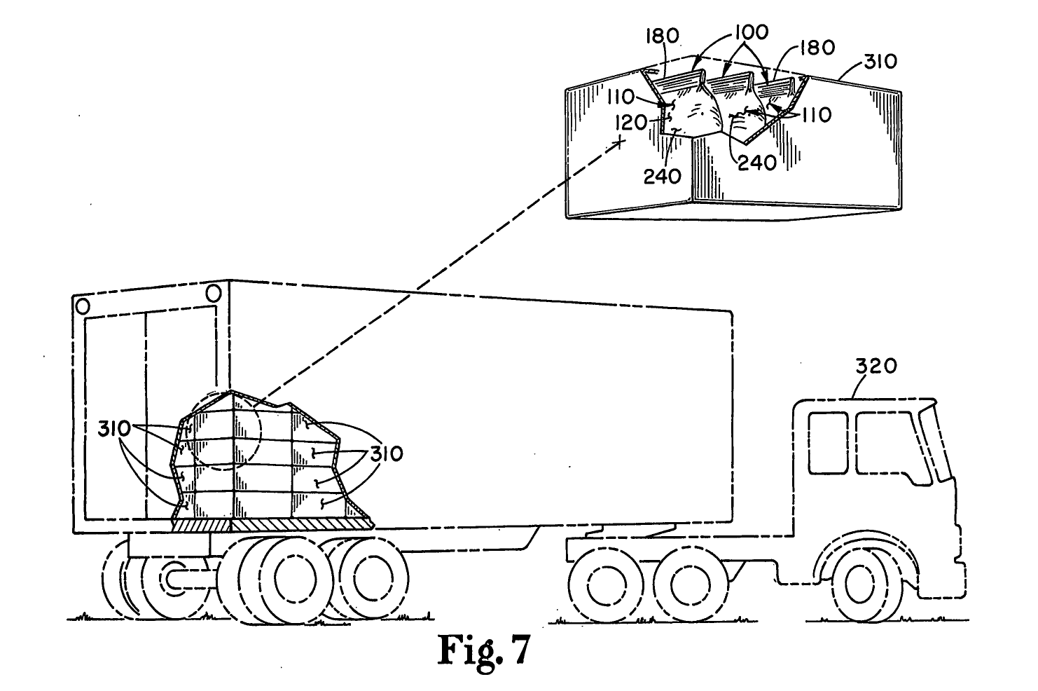

Another preferred embodiment of packaging according to the teachings of the present invention is shown in FIG. 5 as a bag 100. Bag 100 is comprised of a bag body 110 that preferably includes opposing face panels 120. In the preferred form, the face panels 120 have their sides integrally interconnected and in the most preferred form are formed by a single sheet of material which is formed into a tube by either a lap seal or a fin seal. The bag body 110 is sealed at seals 160 and 180 by simply sealing closed the opposing face panels 120 at their lower and upper portions, respectively. This configuration provides for an internal storage region 200 defined by an inner surface 440 of body 110 within which the particulate product 22 is disposed and an outer surface 240 onto which product or promotional information can be displayed. Notably, directional terminology such as “upper” and “lower” is used for purposes of description and with reference to a desired upright orientation of the bag 100 as shown in FIG. 5, with product or promotional information being typically presented for reading when in that orientation. However, the bag body 110 can be positioned in other orientations such that the directional terminology is in no way limiting.

Panels 120 and bag 100 are preferably formed from flexible material that will not take a dead fold and that is unable to provide structural support to the particulate product 22 disposed in the internal storage region 200. Further, in the case where the particulate product 22 is snacks which are more moisture sensitive than ready-to-eat cereals, panels 120 and bag 100 have a lower moisture permeability in the order often times that of panels 12 and canister 10. However, the material should have a relatively high residual memory to create a high hoop strength such that bag 100 will tend to provide a living spring to return to its desired packed shape. In a most preferred form, material in the form of plastics such as polypropylene, polyethylene, and polyesters as well as various copolymers, blends or combinations can be used. Additionally, the material may include aluminum foil, metalized films or other barrier compositions that have been condensed or coated onto one or more layers of plastic. In the most preferred form, a metalized oriented polypropylene layer having a copolymer sealant is laminated to a layer of lower density polyethylene which includes ink forming the product or promotional information and in turn laminated to a layer or oriented polypropylene. Generally, bag 100 can be formed of any material providing an effective barrier for moisture, flavors, aromas, oxygen, insects and dirt from egressing or ingressing to the internal storage region 200.

Due to the sealable nature of the bag 100, at least one microhole 400 is imparted into the body 110 of the bag 100 as shown in FIG. 6. As a point of reference, the at least one microhole 400 is shown as extending through the interconnection of the sides of the face panels 120 at a spacing S from the seal 180 approximately one third of the distance between the seals 160 and 180. In the most preferred form, if more than one microhole 400 is imparted, such microholes 400 are imparted in a linear arrangement in the same interconnection of the sides of the face panels 120 with linear spacing of ½ inch (1.27 cm.). It shall be understood, however, that microhole(s) 400 may be formed in both interconnections, if more than one microhole 400 is provided and one or both face panels 120 located spaced inwardly of the seals 160 and 180. Each microhole 400 extends between the outer surface 240 and the inner surface 440. With this configuration, the microhole(s) 400 provides for exchange of air between the inside and outside of the packaging and particularly for fluid communication between the internal storage region 200 and the atmosphere surrounding the panels 120 and thus the bag body 110. Thus, the microhole(s) 400 allows for air flow into and out of the internal storage region 200 that is otherwise sealed by the bag body 110.

The parameters of the diameter and mass production of the microhole(s) 400 are generally the same as set forth relating to the microholes 40, which description is incorporated here by reference. However, the air flow that is provided by the microhole(s) 400 in the bag 100 is considerably greater than provided by the microholes 40 in the canister 10. Specifically, body 110 is formed by flexible material of a thickness in the preferred form in the order of 2 to 3 mills (0.051 to 0.076 mm) whereas the body 10 is formed of panel material of a thickness in the preferred form in the order of 20 mills (0.51 mm). As a result, the length of microhole(s) 400 is considerably smaller than the microhole 40. As resistance to air flow is directly dependent on length, microhole(s) 400 provides less resistance to air flow than microholes 40 so that greater air flow is provided. Additionally, microholes 40 and 400 are typically not cylindrical shaped but are frustoconical in shape, especially when formed by lasers. Although having the same beginning diameters, microholes 40 tend to have smaller minimum diameters than microholes 400 such that greater air flow is permitted through microholes 400. Also, the material from which bodies 10 and 110 are created can have an impact on air flow.

One preferred method of manufacturing bag 100 is that microhole(s) 400 are imparted in the single sheet of material before it is formed into a tube by providing a lap or fin seal. In the most preferred form and especially when microhole(s) 400 are formed by lasers, microhole(s) 400 are formed in the same position in each body 110, any volatiles created by the laser will be the same to insure the safety of the particulate product 22, the consumers of the particulate product 22 as well as the fabricators. In this regard, different color dyes present in the graphics on panels 120 could produce different volatiles.

After microhole(s) 400 are imparted in the sheet and the sheet formed into the tube, the lower portions of the face panels 120 can be sealed at the seal 160, the particulate product 22 can be placed in the bag body 110, and the upper portions of the face panels 120 can be sealed at the seal 180. It should be appreciated that in addition to the particulate product 22, a volume of air is present in the internal storage region 220, including air that surrounds and is between discrete pieces of the particulate product 22 and air that is contained within the lattice or cellular structure of the particulate product 22 itself. This volume of air provides a cushion that prevents breakage of the particulate product 22 in handling or distribution.

For handling and distributing a plurality of packaged good articles 300 formed by the particulate product 22 and air sealed in the internal storage region 200 of the sealed bag 100 are placed in a paperboard carton or shipper 310. To prevent blockage of the microhole(s) 400 by the particulate product 22, the packaged good articles 300 are placed in the shipper 310 in a vertical orientation with the upper seal 180 located vertically above and in line with the lower seal 160. The shippers 310 are sized to prevent any one of the packaged good articles 300 contained therein to tilt or tip from the vertical orientation during handling and distribution. The packaged good articles 300 can have any desired pack pattern inside the shipper 310 which maximizes the number of the packaged good articles 300 and which minimizes the volume required and the material needed for the shippers 310, such as in a herringbone pattern.

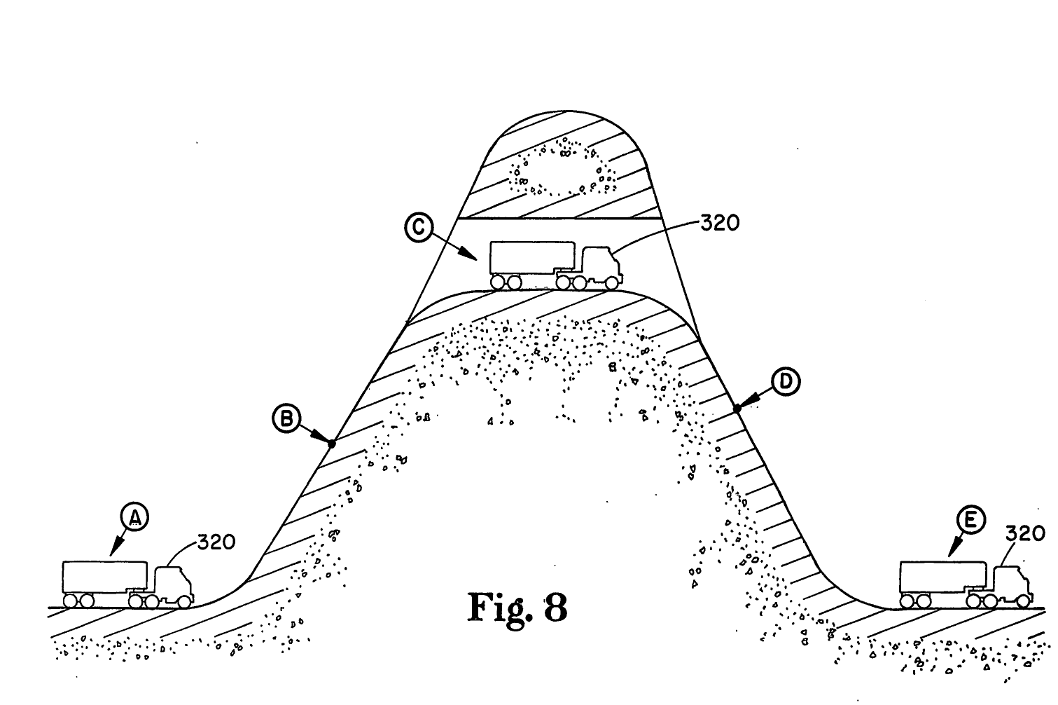

An important concern related to the step of creating microhole(s) 400 is determining a relatively exact number of microhole(s) 400 required. More particularly, microhole(s) 400 provides for venting of air from the internal storage region 200 upon a decrease in atmospheric or barometric pressure acting on the exterior of the bag 100. This situation commonly occurs shipping the packaged good articles 300 from a low altitude location to a high altitude location. In particular, a typical manner of shipping packaged good articles 300 is by truck 320. In the preferred form, a plurality of shippers 310 each containing a plurality of packaged good articles 300 are placed in the truck 320 with all of the shippers 310 being arranged in the truck 320 such that the packaged good articles 300 all are in a vertical orientation while in the truck 320. Again, this reduces the possibility that the particulate product 22 could block the microhole(s) 400 in the bag 100. Shipment from a low altitude location to a high altitude location is diagrammatically represented by movement of the truck 320 over a mountain as diagrammatically shown in FIG. 8. Such a situation would arise when shipping packaged good articles 300 from the Midwest to the West Coast over the Rocky Mountains in the United States of America. However, other situations could arise where shipment occurs from a lower altitude to a higher altitude. In particular, the truck 320 including the packaged good articles 300 could move from point A to point B or C or from point B to point C. In FIG. 8, points A or B could represent the altitude of the manufacturing or distribution center for the packaged good articles 300 while point C would represent the maximum altitude that the truck 320 would attain such as while passing through a pass or tunnel in the mountain range.

Under the circumstances of shipping from a low altitude location such as from point A or point B to a high altitude location such as to points B or C or point C, respectively, the increase in altitude corresponds with a decrease in atmospheric pressure, requiring the venting of air from the internal storage region 200 to maintain integrity of the bag 100. With this in mind, a desired number of microhole(s) 400 directly relates to the amount of air within the internal storage region 200, the change in expected altitude and therefore atmospheric pressure, and the rate at which the bag 100 will experience the change in the altitude and therefore atmospheric pressure.

For bags 100, it is important to note that the pouch volume is constrained by the rigid shipper 310 around it, or in other words, the maximum pouch volume is defined by the space available within the rigid shipper 310 that surrounds it. Assuming that the packaged good articles 300 are identical in size, shape and content and placed into the shipper 310 correctly, each packaged good article 300 will expand to its maximum volume of the shipper 310 or in other words the fractional share of one over the total number of packaged good articles 300 in the shipper 310 of the total volume of the shipper 310. The packaged good articles 300 will expand with increasing altitude until they reach their maximum volume. If bags 100 increase in elevation beyond that point, the internal pressure will exceed the strength of seals 160 or 180 or the material forming the body 110 creating a major defect in the bag 100. It should then be appreciated that although dealing with package integrity, bags 100 have a different concern than canister 10, particularly bursting versus expansion. As such the maximum pressure differential for bags 100 can be substantially greater than and specifically in the order of ten times greater than for canisters 10, and particularly in the order of 1 psi (70 grams per cm²) for bags 100 versus in the order of 0.1 psi (7 grams per cm²) for canisters 10. It should then be appreciated that as air flow is directly dependent upon pressure differential, greater air flow is created through the same size opening under greater pressure differential. This factor as well as other factors result in increased air flow and allow the number of microhole(s) 400 provided in the bag 100 to be significantly less than and particularly in an order of magnitude less than the number of microholes 40 needed to be provided in canister 10.

Talking into account the most extreme conditions of an increase of 8500 feet (2600 meters) in one hour in the United States of America, the minimum rate at which air should vent can be determined by the following equation:

$$\text{Air Vent Rate} = \frac{0.11 ( PVM - VDCP )}{Hour}$$

Where:
PVM=maximum pouch volume
VDCP=volume displacement of compressed product

The total cross-sectional area of microhole(s) 400 can be then determined which will provide an air vent rate according to the above formula. According to the teachings of the present invention, the number of microhole(s) 400 should be minimized to minimize moisture exchange while still providing the minimum air vent rate, with the number of microhole(s) 400 for the bag 100 according to the teachings of the present invention being in the order of 1 to 10 and most preferably 1 to 6. For example, a bag 100 intended to be shipped by truck 320 having a volume of air in the order of 1000 cm³ should include one microhole 400 while having a volume of air in the order of 3000 cm³ should include a maximum of six microholes 400. With proper venting, the external and internal pressures acting upon the bag 100 will remain in substantial equilibrium. Therefore, the bag 100 will not unexpectedly expand and burst.

It can be appreciated that consumers, especially of particulate product 22 in the form of snacks have a favorable perception when packaged good articles 300 include a volume of air to have an inflated shape and specifically to be pillow shaped. This is contrary to many food products such as can goods where inflated appearances have a negative connotation. This perception and the lack of cushion effect are reasons why many snack products are not vacuum packed.

Although canisters 10 and bags 100 are at the maximum altitude when the trucks 320 move through passes or tunnels represented as point C in FIG. 8, canisters 10 and bags 100 are retailed at lower altitudes represented by points D and E in FIG. 8, as most cities of any significant size are located at altitudes lower than at passes or tunnels in the mountains. As the truck 320 and packaged good articles 300 being transported thereby move from higher altitudes to lower altitudes, truck 320 and the packaged good articles 300 are subjected to an increase in atmospheric pressure. It should be appreciated that when air pressure is forced out of a ball by being subjected to outside pressure, such balls normally do not reinflate when that outside pressure is reduced or removed. It was assumed that once the air was vented out of the bag 100 as a result of being shipped from a low altitude to a high altitude location, the bag 100 would not reinflate. However, a totally unexpected and surprising result can be accomplished utilizing microhole(s) 400 in the bags 100 constructed according to the teachings of the present invention formed of flexible material which relies upon internal air to form its final shape as opposed to canisters 10 having a shape determined by the shape of the material from which it is formed. In particular, if the material forming body 110 has a tendency to return to its inflated shape, bags 100 will tend to inflate when moving from a higher altitude to a lower altitude. Specifically, such a tendency to return to its inflated shape can be produced because of the hoop strength of the material forming the bag body 110. One major factor of hoop strength is the force of the material to attempt to return to a flat sheet from the tube configuration defining the bag body 110. Also, the residual memory of the material forming bags 100 to return to its inflated shape and similar factors would all result in the inflation of bag 100 when moved from a higher altitude to a lower altitude by the introduction of air into the internal storage region 200 though microhole(s) 400. In particular, as truck 320 travels from point A or B to point C, air will vent through microhole(s) 400 out of internal storage region 200 and specifically in a manner to prevent a defect in the bag 100 according to the teachings of the present invention. However, with bags 100 constructed according to the teachings of the present invention, air will vent through microhole(s) 400 into internal storage region 200 to reinflate or in other words to include more air than it included at higher altitudes such as point C in FIG. 8.

It should also be appreciated that packaged good articles 300 under normal manufacturing conditions are not fully inflated to their maximum pouch volume for a variety of reasons including that the sealing jaws will tend to flatten the face panels 120 when forming the last seal 160 or 180, operating temperatures or the like. Using the phenomena discovered for the present invention, it is possible to fabricate packaged good articles 300 at higher altitudes for shipment to lower altitudes such as from point B to point A or E in FIG. 8, with packaged good articles 300 possibly inflating or in other words including more air at its point of retail than if included at its point of manufacture.

Prior to the present invention, it was common to set up multiple manufacturing locations for snacks so that it was not necessary to ship products over detrimental altitudes or to restrict sales to a certain location. However, restriction in distribution is often difficult for manufacturers, especially where the manufacturers sell to wholesalers buying in quantity at one location for redistribution by the wholesaler to many other locations at least some of which requiring shipment over high altitudes. Also, multiple manufacturing locations increase capital costs and often reducing capacity efficiencies. Thus, packaged good articles 300 produced according to the teachings of the present invention achieve beneficial results over conventional manufacturing processes.

Although in the preferred form bag 100 is sold without the added protection of a paperboard carton, bag 100 could be retailed in a paperboard carton such as in a “bag in a box” configuration according to the teachings of the present invention.

Although a typical manner of shipment of particulate product 22 in the form of food products and particularly ready-to-eat cereal and snacks is by truck 320 due to their relatively large volume versus weight ratio, microholes 40 and 400 can have application to shipment by air and to other types of packaging than canisters 10 and bags 100 according to the teachings of the present invention.

Although formed in the most preferred from utilizing lasers, microholes 40 and 400 could be imparted in the material forming the packaging by other means according to the teachings of the patent invention. In this regard, formation by laser is believed to be advantageous over mechanical means which have a greater possibility of resealing after imparting and have a risk of including broken metal components with the particulate product 22 which is understandably undesired for food products.

Although the present invention has been described with reference to preferred embodiments, workers skilled in the art will recognize that changes may be made in form and detail without departing from the spirit and scope of the present invention. For example, the canister has been depicted as being generally rectangular in shape. Alternatively, other shapes are equally acceptable. Also, the canister can contain items in addition to the particulate-type product described. For example, a separate coupon or premium can be placed in the canister along with the particulate-type product.

1. Packaging for containing a particulate product, the packaging comprising:
a body defining an internal storage region; and
at least one microhole formed in the body sized for allowing air communication with the internal storage region due to changes in atmospheric pressure as a result of an altitude change and for limiting passage of the particulate product from the internal storage region;
wherein except for the at least one microhole, the body is constructed for sealing of the internal storage region about the particulate product while the air communication occurs.

2. The packaging of claim 1, wherein the body has an internal pressure, and further wherein the at least one microhole is configured such that upon a decrease in atmospheric pressure, a volume of air vents through the at least one microhole.

3. The packaging of claim 1, wherein the at least one microhole is configured to vent air from the internal storage region at a rate to maintain pressure equilibrium as the canister is raised from a minimum altitude to a maximum altitude.

4. The packaging of claim 1, wherein the at least one microhole is sized to prevent passage of contaminants into the internal storage region.

5. The packaging of claim 1, wherein the at least one microhole includes a plurality of microholes which are uniformly sized.

6. The packaging of claim 1, wherein the at least one microhole has a diameter in the range of approximately 10-100 micrometers.

7. The packaging of claim 1, wherein the at least one microhole has a diameter of approximately 70 micrometers.

8. The packaging of claim 1, wherein a total cross-sectional area of the at least one microhole is related to a volume of the internal storage region.

9. The packaging of claim 8, wherein the total cross-sectional area of the at least one microhole is further related to a compressed volume of particulate product contained within the internal storage region.

10. The packaging of claim 1, wherein the internal storage region has a volume in the range of approximately 2,000-4,000 cm³, the particulate product has a volume in the range of approximately 200-800 cm³, and the at least one microhole has a total cross-sectional area in the range of approximately 0.001-0.004 cm².

11. The packaging of claim 1, wherein the internal storage region has a volume of approximately 3,145 cm³, the at least one microhole has a total cross-sectional area of approximately 0.0024 cm² and the air flow rate from the internal storage region is about 0.31 cm³/sec.

12. The packaging of claim 1, wherein the internal storage region has a volume in the range of approximately 2,000-4,000 cm³, the particulate product has a compressed volume in the range of approximately 200-800 cm³, and the at least one microhole includes approximately 40-100 microholes.

13. The packaging of claim 1, wherein the body includes:
opposing face panels;
opposing side panels connected to the opposing face panels to define an upper opening and a lower opening;
a bottom panel connected to the opposing face panels and the opposing side panels so as to encompass the lower opening; and
a top panel connected to the opposing face panels and the opposing side panels so as to encompass the lower opening.

14. The packaging of claim 13, wherein each of the panels includes a plastic material configured to maintain integrity of particulate product disposed within the internal storage region.

15. The packaging of claim 1, wherein the body is configured to contain a dry food product.

16. The packaging of claim 15, wherein the food product is a ready-to-eat cereal.

17. The packaging of claim 1, wherein the body includes:
opposing face panels having their sides integrally connected and including lower and upper portions;
and lower and upper seals closing the opposing face panels at the upper and lower portions, with the face panels formed of flexible material to create a bag.

18. The packaging of claim 17, wherein the flexible material creating the bag has a tendency to return to an inflated shape after a volume of air is vented from the internal storage region due to a reduction of atmospheric pressure and then an increase in atmospheric pressure.

19. The packaging of claim 18, wherein the body is configured to contain a dry food product in the form of a snack.

20. A packaged good article comprising:
a packaging including:
a body defining an internal storage region,
at least one microhole formed in the body sized to allow air communication with the internal storage region due to changes in atmospheric pressures as a result of an altitude change; and
a particulate product disposed within the internal storage region;
wherein the at least one microhole is sized to prevent release of the particulate product with the body being constructed to seal the internal storage region about the particulate product except for the at least one microhole.

21. The packaged good article of claim 20, wherein the body has an internal pressure, and further wherein the at least one microhole is configured such that upon a decrease in atmospheric pressure, a volume of air vents through the at least one microhole.

22. The packaged good article of claim 20, wherein the at least one microhole is configured to vent air from the internal storage region at a rate to maintain pressure equilibrium as the canister is raised from a minimum altitude to a maximum altitude.

23. The packaged good article of claim 20, wherein the at least one microhole is sized to prevent passage of contaminants into the internal storage region.

24. The packaged good article of claim 20, wherein the at least one microhole includes a plurality of microholes which are uniformly sized.

25. The packaged good article of claim 20, wherein the at least one microhole has a diameter of approximately 10-100 micrometers.

26. The packaged good article of claim 20, wherein the at least one microhole has a diameter of approximately 70 micrometers.

27. The packaged good article of any one of claims claim 20, wherein a total cross-sectional area of the at least one microhole is related to a volume of the internal storage region.

28. The packaged good article of claim 27, wherein the total cross-sectional area of the at least one microhole is further related to a volume of air contained within the internal storage region.

29. The packaged good article of claim 20, wherein the internal storage region has a volume in the range of approximately 2,000-4,000 cm³ of which air occupies approximately 80-95 percent, and the at least one microhole has a total cross-sectional area in the range of approximately 0.001-0.004 cm².

30. The packaged good article of claim 20, wherein the internal storage region has a volume of approximately 3,145 cm³ and the at least one microhole has a total cross-sectional area of approximately 0.0024 cm².

31. The packaged good article of claim 20, wherein the internal storage region has a volume in the range of approximately 2,000-4,000 cm³ of which air occupies approximately 80-95 percent, and the at least one microhole includes approximately 40-100 microholes.

32. The packaged good article of claim 20, wherein the body includes:
opposing face panels;
opposing side panels connected to the opposing face panels to define an upper opening and a lower opening;
a bottom panel connected to the opposing face panels and the opposing side panels so as to encompass the lower opening; and
a top panel connected to the opposing face panels and the opposing side panels so as to encompass the lower opening.

33. The packaged good article of claim 32, wherein each of the panels include a plastic material configured to maintain integrity of the particulate product.

34. The packaged good article of claim 20, wherein the particulate product is a dry food product.

35. The packaged good article of claim 34, wherein the food product is a ready-to-eat cereal.

36. The packaged good article of claim 20, wherein the body includes:
opposing face panels having their sides integrally connected and including lower and upper portions; and
lower and upper seals closing the opposing face panels at the upper and lower portions, with the face panels formed of flexible material to create a bag.

37. The packaged good article of claim 36, wherein the flexible material creating the bag has a tendency to return to an inflated shape after a volume of air is vented from the internal storage region due to a reduction of atmospheric pressure and then an increase in atmospheric pressure.

38. The packaged good article of claim 37, wherein the body is configured to contain a dry food product in the form of a snack.

39. A method of manufacturing a packaged good article, the method comprising:
forming a sealable packaging having an internal storage region;
imparting at least one microhole into the packaging, the at least one microhole extending from an exterior of the packaging to the internal storage region; and
partially filling the internal storage region with a particulate product, a majority of a remaining volume of the internal storage region being air;
with the air within the internal storage region generating an internal pressure, and further with a change in atmospheric pressure as a result of an altitude change, the at least one microhole providing air communication with the internal storage region.

40. The method of claim 39, wherein imparting the at least one microhole includes:
determining a volume of air required to be vented from the internal storage region to maintain pressure equilibrium when the packaged good article is raised from a minimum altitude to a maximum altitude; and
determining a required number of microholes based upon the volume of air required to be vented.

41. The method of claim 40, wherein determining a required number of microholes further includes:
determining a flow rate of air from the internal storage region required to maintain pressure equilibrium.

42. The method of claim 39, wherein imparting the at least one microhole includes:
determining a total cross-sectional area of microholes required to maintain pressure equilibrium when the packaged good article is raised from a minimum altitude to a maximum altitude; and
determining a required number of microholes based upon the total cross-sectional area.

43. The method of claim 39, wherein imparting the at least one microhole includes:
forming the at least one microhole each having a diameter of approximately 70 micrometers.

44. The method of claim 39, wherein forming the sealable packaging includes:
connecting opposing face panels and opposing side panels to form a tubular body having an upper opening and a lower opening;
connecting a top panel to the opposing face panels and the opposing side panels so as to encompass the upper opening; and
connecting a bottom panel to the opposing face panels and the opposing side panels so as to encompass the lower opening.

45. The method of claim 44, wherein the internal storage region is partially filled with the particulate product prior to connecting the bottom panel.

46. The method of claim 39, wherein the particulate product is a ready-to-eat cereal.

47. The method of claim 39, wherein forming the sealable packaging includes:
connecting opposing face panels to form a tubular body having upper and lower portions;
sealing the upper portions; and
sealing the lower portions.

48. The method of claim 47, wherein the internal storage region is partially filled with the particulate product after sealing one of the upper and lower portions and prior to sealing the other of the upper and lower portions.

49. The method of claim 47, with connecting opposing face panels comprising connecting opposing face panels formed of flexible material such that the shape of the packaging being formed into a final shape relying upon the air in the internal storage region.

50. A method of shipping a particulate product, the method comprising: sealing the particulate product within an internal storage region of a packaging; imparting at least one microhole adjacent an upper portion of the packaging, with the at least one microhole being sized to provide air communication with the internal storage region due to changes in atmospheric pressure as a result of an altitude change; packing a plurality of the sealed packaging in a pack pattern in a shipper with the packaging each being a vertical orientation; stacking a plurality of shippers with the packaging in each of the shippers being in the vertical orientation; and shipping the stack of shippers from a first altitude to a second altitude different from the first altitude causing air to flow through the at least one microhole.

51. The method of claim 50, with sealing the particulate product comprising sealing the particulate product with a volume of air within the internal storage region of the packaging formed of flexible material and relying upon the volume of air to form a final shape; and with shipping the stack of shippers comprising shipping the stack of shippers from a high altitude to a low altitude.

52. The method of claim 51, with shipping the stack of shippers comprising shipping the stack of shippers from the high altitude to a higher altitude and then to the low altitude.

53. The method of claim 47, with shipping the stack of shippers comprising shipping the stack of shippers from a low altitude to a high altitude.

54. The method of claim 51, with shipping the stack of shippers comprising shipping the stack of shippers from the high altitude to an altitude less than the high altitude.

55. The method of claim 53, with sealing the particulate product comprising sealing the particulate product with a volume of air within the internal storage region of the packaging formed of flexible material and relying upon the volume of air to form a final shape.

56. The method of claims 55, with sealing the particulate product comprising sealing the particulate product in a bag formed by opposing face panels having sides integrally interconnected and sealing closed at upper and lower portions; and with imparting at least one microhole comprising imparting at least one microhole in the interconnection between the sides of the face panels.

57. The method of any one of claims 50, with imparting at least one microhole comprising imparting at least one microhole having a diameter in the range of approximately 10-1000 micrometers.

58. The method of any one of claims 50, with imparting at least one microhole comprising imparting at least one microhole having a total cross sectional area providing an air vent rate to prevent a pressure differential between the internal storage region and the atmosphere surrounding the packaging to exceed a bursting strength of the packaging.

59. The method of any one of claims 50, with shipping the stack of shippers comprising trucking the stack of shippers.

60-62. (cancelled).
